(19) United States
(12) Patent Application Publication
(10) Pub. No.: US 2015/0106189 A1
(43) Pub. Date: Apr. 16, 2015

(54) Real-Time Marketing Campaign System and Method

(71) Applicant: WILopEN Products, LC, Deerfield Beach, FL (US)

(72) Inventor: Gregory Spencer Dean, New Smyrna, FL (US)

(21) Appl. No.: 14/514,144

(22) Filed: Oct. 14, 2014

Related U.S. Application Data
(60) Provisional application No. 61/889,986, filed on Oct. 11, 2013.
(60) Provisional application No. 61/924,877, filed on Jan. 8, 2014.

(51) Int. Cl. G06Q 30/02

(52) U.S. Cl. CPC G06Q 30/0242
USPC 705/14.41

(57) ABSTRACT

A system and method is provided to enhance marketing having a monitoring engine to collect data relating to a campaign, an analysis engine to analyze the data and generate information, and an interface to access the information. The system may be accessible via a network. The system may analyze the data, provide information, and manipulate a marketing campaign in approximately real-time.

### CROSS-REFERENCE TO RELATED APPLICATIONS

This application is a nonprovisional application of and claims priority from U.S. provisional patent application Ser. No. 61/889,986 filed on Oct. 11, 2013 and U.S. provisional patent application Ser. No. 61/924,877 filed on Jan. 8, 2014. The foregoing applications are incorporated in their entirety herein by reference.

### FIELD OF THE INVENTION

The present invention relates to a computerized marketing system. More particularly, the present invention relates to a computerized marketing system capable of determining trends.

### BACKGROUND

Numerous systems exist to capture information and provide reports regarding effectiveness of marketing campaigns. Google Analytics, for example, includes an interface for companies and individuals to view the number of hits, unique impressions, and other Internet specific statistics important for an Internet marketer. This information is limited to who and when, but does not explain why. However, as with services such as Google Analytics, the hits and impressions are tracked to a nameless, faceless IP address. For purposes of direct marketing, such conventional services present disadvantages as timing is very important in direct marketing.

What is needed is a system capable of monitoring a marketing campaign, including the ability to monitor multiple campaigns across multiple initiatives with the capability to organize and present the analyzed data for review. A further need exists for a system to monitor and analyze statistical data in approximately real-time for use in selectively altering an advertising and marketing campaign based on a target's demographical characteristics and known or predicted product preferences and other individual likes and dislikes. What is needed is a method to analyze a marketing campaign using a computerized system.

### SUMMARY

The present invention relates to computerized systems and methods for creating and analyzing marketing campaigns. More particularly, the invention relates to computerized systems for marketing campaigns, systems for analyzing marketing campaigns, and methods that utilize approximately real-time statistics. The present invention relates to response analytics related to consumers or other marketing campaign targets to modify marketing campaigns in real time as necessitated by changes in trends discerned from the statistics and response analytics.

The present invention advantageously provides a system capable of monitoring a marketing campaign. Additionally, the present invention advantageously provides a system to monitor multiple campaigns across multiple initiatives. The present invention also provides a system to monitor and analyze statistical data in approximately real-time. Moreover, the present invention provides a system to organize and present the analyzed data. The present invention provides a system to facilitate finely tuning an advertising and marketing campaign. The present invention provides a method to analyze a marketing campaign using a computerized system.

According to an embodiment of the present invention, a system is provided to enhance marketing including a monitoring engine, an analysis engine, and an interface. The monitoring engine may collect data relating to a response to a campaign. The analysis engine may analyze the data to generate information. The interface may access the information.

In another aspect, the interface may include a dashboard to display the information and a form usable to define a campaign and manipulate the campaign that exists.

In another aspect, the system may be accessible via a network.

In another aspect, the analysis engine may manipulate the campaign in response to the data that is analyzed.

In another aspect, the analysis engine may manipulate the campaign substantially automatically via differentiation.

In another aspect, the campaign may be manipulable while the campaign is active.

In another aspect, the campaign is manipulable without stopping the campaign.

In another aspect, at least part of a plurality of campaigns may be operable substantially simultaneously.

In another aspect, the campaign may be targeted for a responder.

In another aspect, the system may include a profiling engine to associate the information with the responder.

In another aspect, the system may include a modeling engine to analyze the information associated with the responder and predict future results. The modeling engine may determine the best course of action for future campaigns.

In another aspect, the profiling engine may associate the information with the responder and the modeling engine may predict the future results approximately instantaneously as the information is generated by the analysis engine from the data. The modeling engine may use approximately real-time analysis to provide near constant feedback as to the predicted response rate for an active campaign.

In another aspect, the monitoring engine may operate continuously to collect the data.

According to an embodiment of the present invention, a marketing enhancement system accessible via a network is provided including a monitoring engine, an analysis engine, a profiling engine, and a modeling engine. The monitoring engine may collect data relating to a response to a campaign by a responder. The analysis engine may analyze the data to generate information. The profiling engine may associate the information with the responder. The modeling engine may analyze the information associated with the responder and predict future results. A plurality of campaigns may be operable substantially simultaneously.

In another aspect, the system may include an interface to access the information. The interface may further include a dashboard to display the information and a form usable to define a new campaign targeted for the responder and manipulate an existing campaign.

In another aspect, the analysis engine may manipulate the existing campaign in response to the data that is analyzed while the existing campaign is active and without stopping the existing campaign.

In another aspect, the analysis engine may manipulate the existing campaign substantially automatically via differentiation.

In another aspect, the monitoring engine may operate substantially continuously to collect the data. The analysis engine may analyze the data and generates the information approximately instantaneously. The profiling engine may associate the information with the responder approximately instantaneously.

According to an embodiment of the present invention, a method is provided for enhancing marketing. The method may include (a) collecting data relating to a response to a campaign from a responder using a monitoring engine. The method may additionally include (b) analyzing the data using an analysis engine to generate information. The method may include (c) providing the information via an interface accessible via a network. The interface may include a dashboard to display the information and a form usable to define a campaign and manipulate the campaign. The method may include (d) receiving commands via the interface to manipulate the campaign. Steps (a), (b), and (c) may occur approximately instantaneously. A plurality of campaigns may be operable substantially simultaneously.

In another aspect, the method may additionally include (e) manipulating the campaign in response to the data that is analyzed while the campaign is active and without stopping the campaign.

In another aspect, the method may further include (f) targeting the campaign by associating the information with the responder via a profiling engine. The profiling engine may associate the information with the responder approximately instantaneously as the information is generated by the analysis engine.

Unless otherwise defined, all technical terms used herein have the same meaning as commonly understood by one of ordinary skill in the art to which this invention belongs. Methods and materials similar or equivalent to those described herein can be used in the practice or testing of the present invention. Suitable methods and materials are described below. All publications, patent applications, patents and other references mentioned herein are incorporated by reference in their entirety. In the case of conflict, the present specification, including definitions will control.

### BRIEF DESCRIPTION OF THE DRAWINGS

FIGS. 1A and 1B are diagrams illustrating a dashboard interface of the marketing system, according to an embodiment of the present invention.

FIG. 2 is a diagram illustrating a campaign list interface of the marketing system, according to an embodiment of the present invention.

FIGS. 3A and 3B are diagrams illustrating a new campaign interface of the marketing system, according to an embodiment of the present invention.

FIG. 4 is a flowchart illustrating a process of the marketing system, according to an embodiment of the present invention.

### DETAILED DESCRIPTION

The present invention is best understood by reference to the detailed drawings and description set forth herein. Embodiments of the invention are discussed below with reference to the drawings; however, those skilled in the art will readily appreciate that the detailed description given herein with respect to these figures is for explanatory purposes as the invention extends beyond these limited embodiments. For example, in light of the teachings of the present invention, those skilled in the art will recognize a multiplicity of alternate and suitable approaches, depending upon the needs of the particular application, to implement the functionality of any given detail described herein beyond the particular implementation choices in the following embodiments described and shown. That is, numerous modifications and variations of the invention may exist that are too numerous to be listed, but that all fit within the scope of the invention. Also, singular words should be read as plural and vice versa and masculine as feminine and vice versa, where appropriate, and alternative embodiments do not necessarily imply that the two are mutually exclusive.

The present invention should not be limited to the particular methodology, compounds, materials, manufacturing techniques, uses, and applications described herein, as these may vary. The terminology used herein is used for the purpose of describing particular embodiments only, and is not intended to limit the scope of the present invention. As used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” may be a reference to one or more steps or means and may include sub-steps and subservient means.

All conjunctions used herein are to be understood in the most inclusive sense possible. Thus, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. Structures described herein are to be understood also to refer to functional equivalents of such structures. Language that may be construed to express approximation should be so understood unless the context clearly dictates otherwise.

Unless otherwise defined, all terms (including technical and scientific terms) are to be given their ordinary and customary meaning to a person of ordinary skill in the art, and are not to be limited to a special or customized meaning unless expressly so defined herein.

Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “having” should be interpreted as “having at least”; the term “includes” should be interpreted as “includes but is not limited to”; the term “example” is used to provide exemplary instances of the item in discussion, not an exhaustive or limiting list thereof; and use of terms like “preferably,” “preferred,” “desired,” “desirable,” or “exemplary” and words of similar meaning should not be understood as implying that certain features are critical, essential, or even important to the structure or function of the invention, but instead as merely intended to highlight alternative or additional features that may or may not be utilized in a particular embodiment of the invention.

Those skilled in the art will also understand that if a specific number of an introduced claim recitation is intended, such an intent will be explicitly recited in the claim, and in the absence of such recitation no such intent is present. For example, as an aid to understanding, the appended claims may contain usage of the introductory phrases “at least one” and “one or more” to introduce claim recitations; however, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

All numbers expressing dimensions, quantities of ingredients, reaction conditions, and so forth used in the specification are to be understood as being modified in all instances by the term “about” unless expressly stated otherwise. Accordingly, unless indicated to the contrary, the numerical parameters set forth herein are approximations that may vary depending upon the desired properties sought to be obtained.

The present invention relates to a system to enhance marketing that may include a monitoring engine, an analysis engine, an interface, a profiling engine, and optionally a modeling engine. The monitoring engine may monitor activity and collect data relating to responses for a campaign. The analysis engine may analyze this data to create information that is usable by the system and/or readable by a user. The interface may present at least part of the information to the user. The profiling engine may associate at least part of the information with a responder to the campaign. The modeling engine may analyze the profile data to determine the best course of action for future campaigns.

The invention may provide a system capable of monitoring consumer trends to improve marketing techniques. The system may monitor the consumer trends using a monitoring engine. The present invention may advantageously provide a constant ear to the ground, such as by substantially continuously monitoring responses, throughout the course of a marketing and/or advertising campaign. Data may be generated by the monitoring engine reflective of the trends, responses, and other usage of a responder. The system of the present invention may be operable across multiple initiatives of a marketing and/or advertising campaign. The approximately real-time statistics and response analytics may provide marketers with the information necessary to fine tune the creative and message strategy of an active campaign approximately instantaneously.

The system may analyze data using an analysis engine to generate information usable to determine how a campaign may be beneficially manipulated. The data may be collected by the monitoring engine discussed above. The analysis engine may transform the collected data into information usable by the system and/or user managing one or more campaign.

Traditionally, direct marketers have become very accustomed to the market-measure-repeat approach to managing multi-touch cross channel campaigns. However, the established approach involves looking back on the effectiveness of a marketing campaign. For example, marketing data and information has been traditionally gathered and interpreted post-campaign into a campaign “epilogue.” However, this reactive approach does not support overlapping campaigns or asynchronous marketing initiatives.

According to an embodiment of the present invention, a system is provided to integrate marketing campaigns with approximately real-time analytics. Additionally, campaign integration methods allow the systems of the instant invention to capture responses approximately as they happen. Responses are interactions by a person or entity targeted by the marketing campaign, such people or entities being responders. For example, virtually every responder, such as a consumer or other marketing campaign target (e.g., retailers or other businesses to whom a business-to-business marketing campaign is targeted), may be analyzed and profiled almost instantaneously as he or she responds.

Profiling may be performed by the profiling engine. Profiling may include demographic, psychographic, and/or geographic information, and may be collected and applied to the profile approximately as the information is generated. As discussed above, the information may be generated by the analysis engine. The information associated with the profile may be analyzed to determine characteristics of a target audience and/or individual. This information may be analyzed and used to alter the course of active campaigns to increase an audience, market penetration, or enhance the effectiveness of a marketing effort. Alteration of the campaign may be applied, for example, in approximately real-time.

Modeling may be performed by the modeling engine. Modeling may include analyzing the response data to build a profile of nearly every responder. The system may generate models using the information, which may be associated with a profile, to predict future results. Future results may include a next group of responders, a calculated response, or other types of anticipated interaction with the system. The modeling engine may assist a user in determining what will happen next with a campaign. The profile may be updated to provide insight as to factors considered by the modeling engine and that may influence changes to the campaign.

The system of the present invention advantageously benefits by differentiation. By including differentiation, the system of the present invention advantageously operates with increased efficiency over prior systems and methods of direct marketing. Differentiation provided by the system of the present invention may include approximately real-time appending of demographic, psychographic, and geographic attributes to a responder's record. Differentiation may also include approximately real-time modeling of information for predicting the next wave of responders (in an active campaign) as well as the probability for a responder to convert. Additionally, differentiation may include derivation of information to enhance making forward-looking decisions for adjusting creative and message strategies of active campaigns.

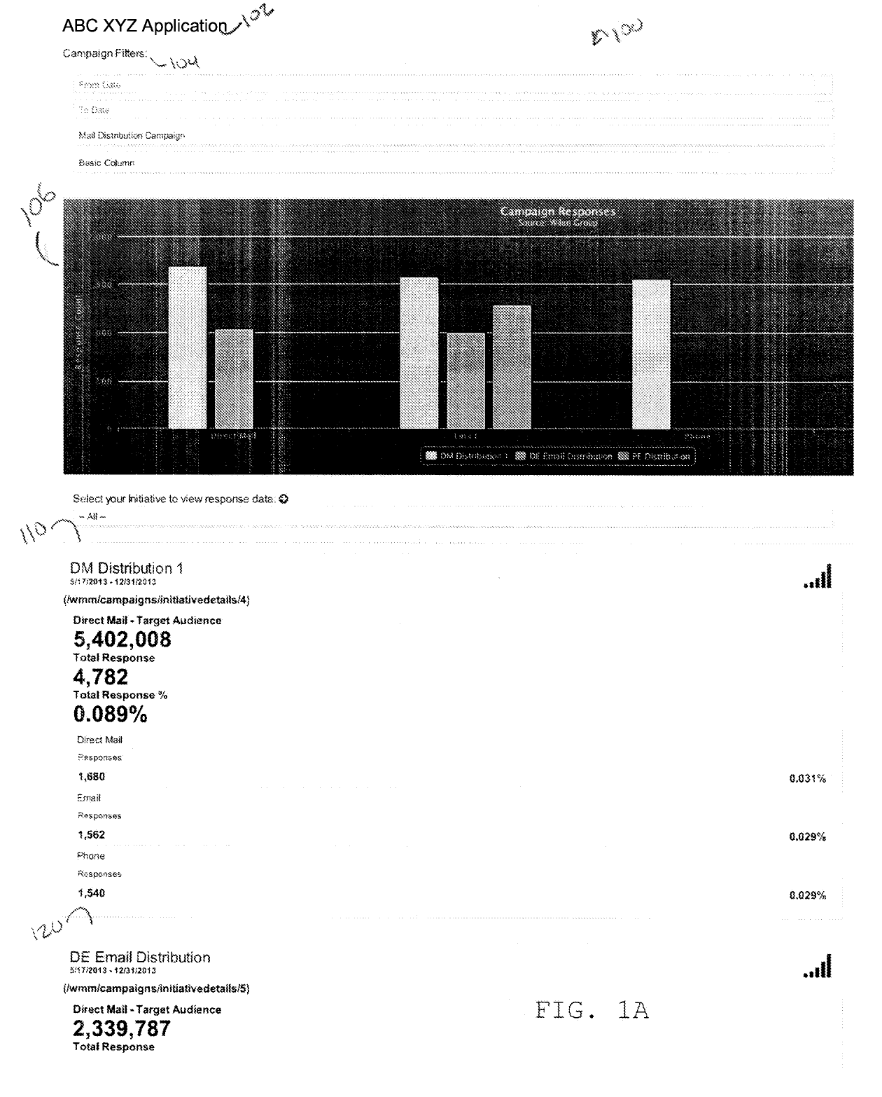

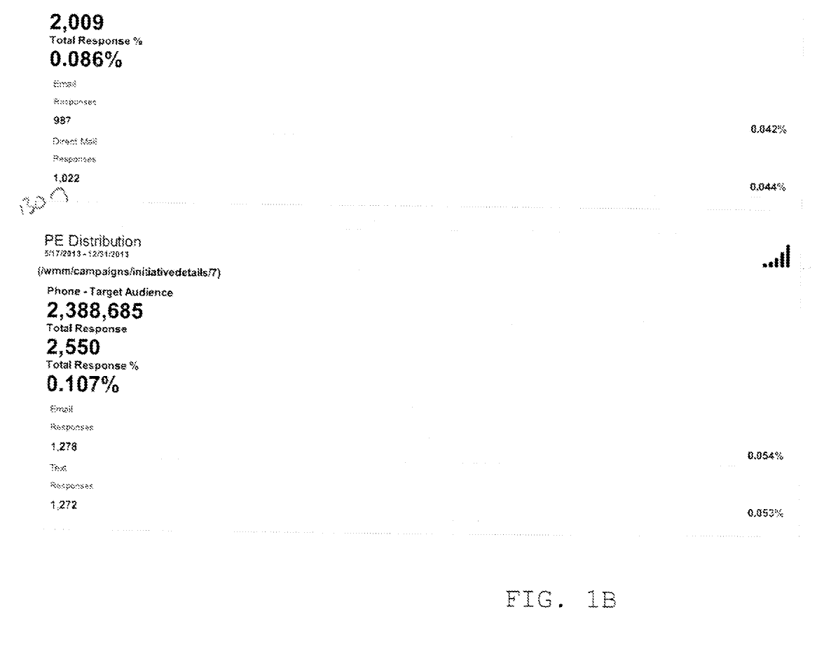

The system of the present invention may be operable on a computerized device. The system may include an interface, such as a dashboard interface. The interface may be accessible through a web browser installed on the computerized device. The interface may be accessible via the Internet over a network connection. The interface may be accessible as non-downloadable software as a service (SaaS) and may be created, for example, using HTML5. The dashboard may include statistics and analytics based on communication channels. The interface may additionally include forms to create and/or manipulate campaigns. Commands may be issued using the interface to affect operation of one or more campaigns. Examples of an interface usable by the system are provided in FIGS. 1-3. Communication channels may include, for example, direct mail, email, etc. to consumers.

Referring to the illustrative interface of FIGS. 1A-1B, an embodiment of a dashboard interface 100 will now be discussed. The dashboard 100 may include a title 102 to identify an application. The dashboard 100 may also include statistics and analytics relating to response channels, such as, for example, responsive communications by a consumer to show interest in response to the marketing campaign, telephone calls, email, and other response communications. The dashboard 100 may display information via bar graphs, performance statistics, realization reports, percentages, response measurements, and other data reports. The information provided by the dashboard may be filtered using one or more filter controls 104. Decisions to change features of the marketing campaign can be made by human or machine in response to changes in demographic and/or statistics collected through the response channels.

The dashboard 100 may include various components that can be viewed and/or manipulated to track information relating to the advertising campaign. The dashboard 100 may also include one or more filters manipulable via filter controls 104. For example, the interface may include a date range filter to specify a starting and ending date for data being reported. Additionally, the interface may include a filter to specify a campaign. A visual reporting component 106 may be provided to visually display information gathered relating to the campaign. The visual reporting component 106 may include a bar graph, pie chart, image, or other form of information that can facilitate viewing viewed and/or assessment by a user.

The dashboard 100 may also include statistical information, for example, analytics for advertising distributions. The statistical information may include a target audience for an advertising campaign, a total response generated by the advertising campaign, and a completion ratio to track progress toward the target. Detailed statistics may also be provided, which may include a number of responses generated from various communication channels.

One or more campaign may operate substantially simultaneously. The dashboard 100 may display statistical information for each of the current marketing campaigns. For example, the illustrative dashboard interface 100 shows example statistical information for a “DM Distribution 1” first campaign 110, “DE Email Distribution” second campaign 120, and “PE Distribution” third campaign 130. Skilled artisans will appreciate additional campaigns may be included by the dashboard 100 without limitation.

As discussed above, the system may be accessed using a computerized device. The system may be accessed via a network, for example, the Internet. The computerized device may include, but should not be limited to, a computer, a tablet computer, a mobile phone, or another device with a processor and memory. The system may be remotely accessed by a user over the network via the interface. The system may be hosted by a server accessible over the network.

Because decisions to change a marketing campaign and the changes themselves may be made in real time in response to real-time statistics and analytics, clients using the system of the present invention may make such changes to the marketing campaign quickly as needed. For example, the system may include a module that permits the client to change direct mail materials being printed by a remote printing press or other printing device that may be digital and/or connected to the Internet.

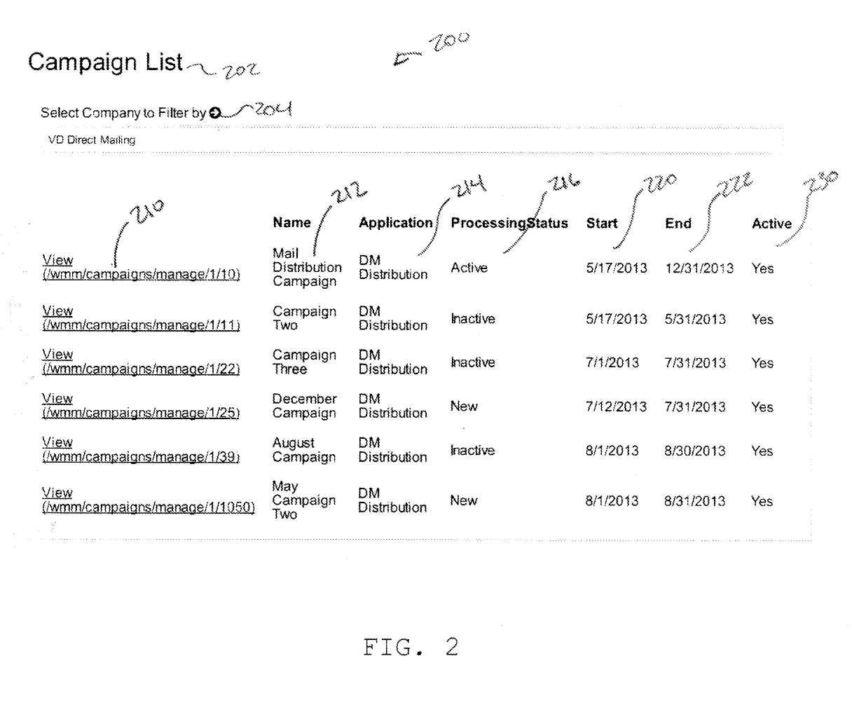

An example of a campaign list 200 of the interface is provided by FIG. 2. The campaign list 200 may include a title 202 to provide information relating to all currently active campaigns. The campaign list 200 may additionally include information about one or more campaigns being managed by the system. For example, the campaign list may include a link to the campaign 210, a name of the campaign 212, an application and/or platform for operating the campaign 214, a processing status of the campaign 216, start and end dates for the campaign 220, 222, and an activity indicator 230 as to whether the campaign is active. The details of the campaign list may also be filtered using filtering controls 204.

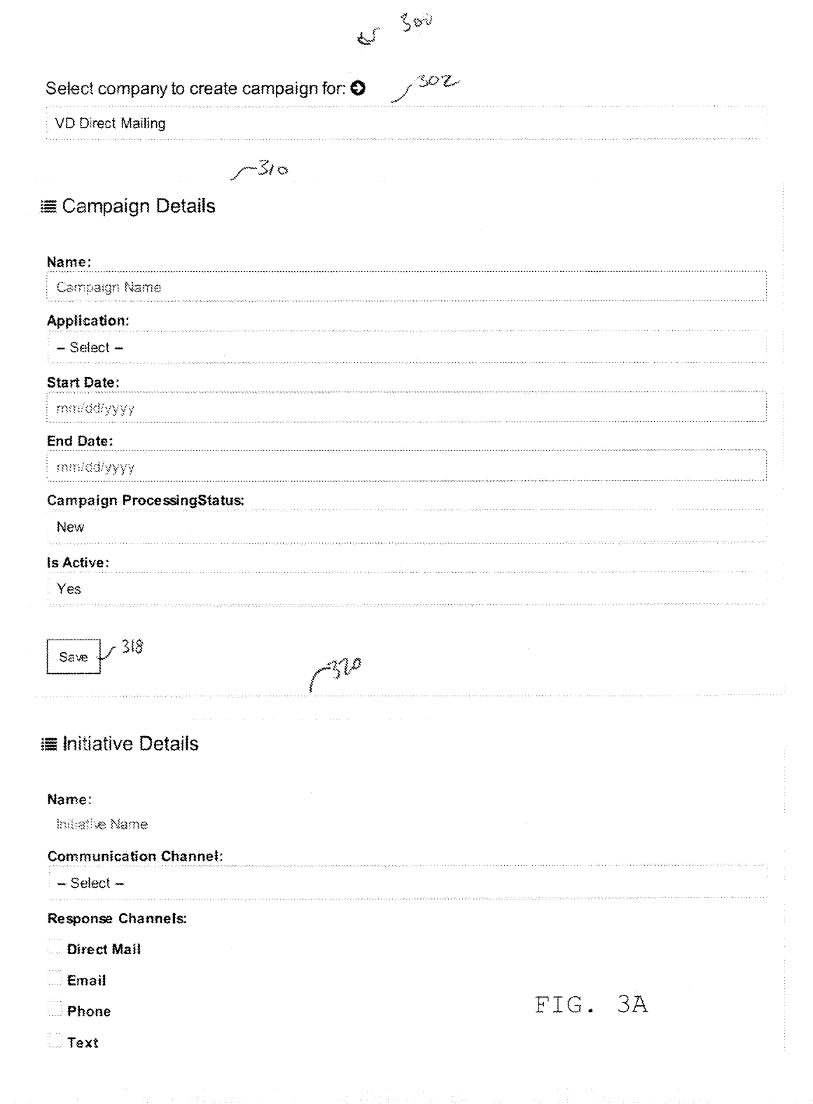

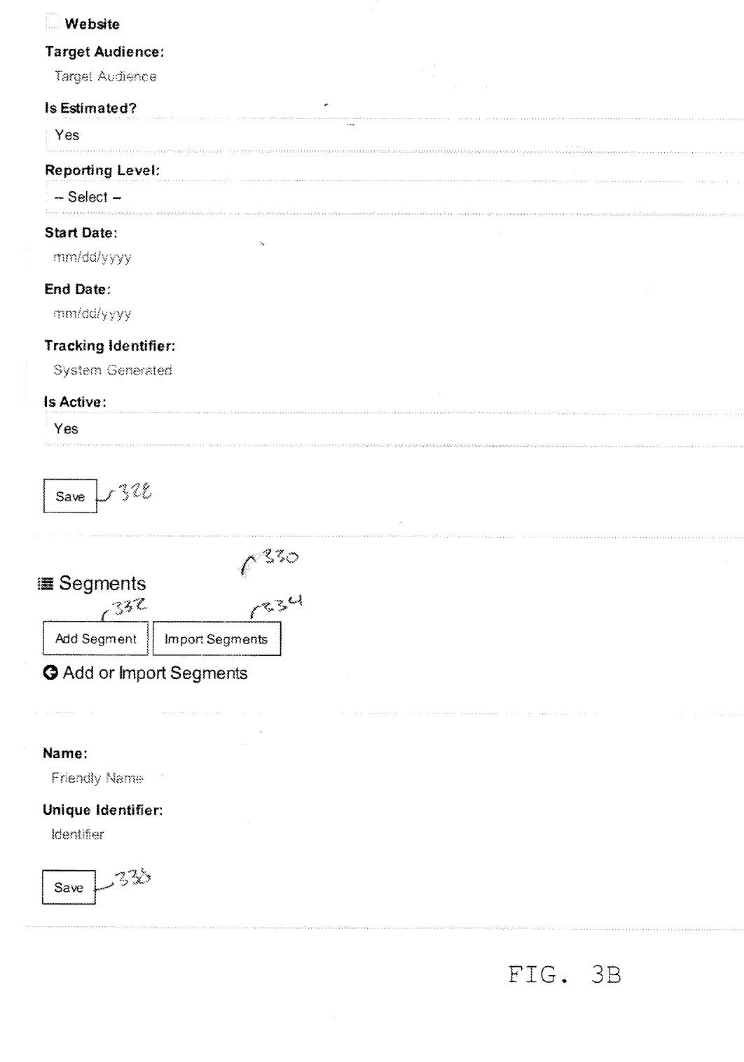

Campaigns may be modified and new campaigns may be created. An example of a new campaign interface 300 is provided by FIGS. 3A and 3B. The new campaign interface 300 may include a title field 302 to define a title or other label for the campaign. The new campaign interface 300 may additionally include a section for campaign details 310 including fields for name, application, start date, end date, campaign processing status, active status, and/or other information. The campaign details may include a save button 318.

The new campaign interface may also include a section for initiative details 320, including fields for name, communication channel, response channels, target audience, estimation, reporting level, start date, end date, tracking identifier, active status, and/or other information. The initiative details may include a save button 328.

The new campaign interface may include a section for segments 330. The segments may include options to add a segment 332 and/or import a segment 334. The segment section may include a save button 338.

A customer's experience on a website may also be customized by automated process and rules established for a marketing campaign targeted at consumers having certain demographic characteristics. Based on demographic statistics and analytics obtained from consumers through response channels, specific goods and services can be marketed to each user using predictive analytics.

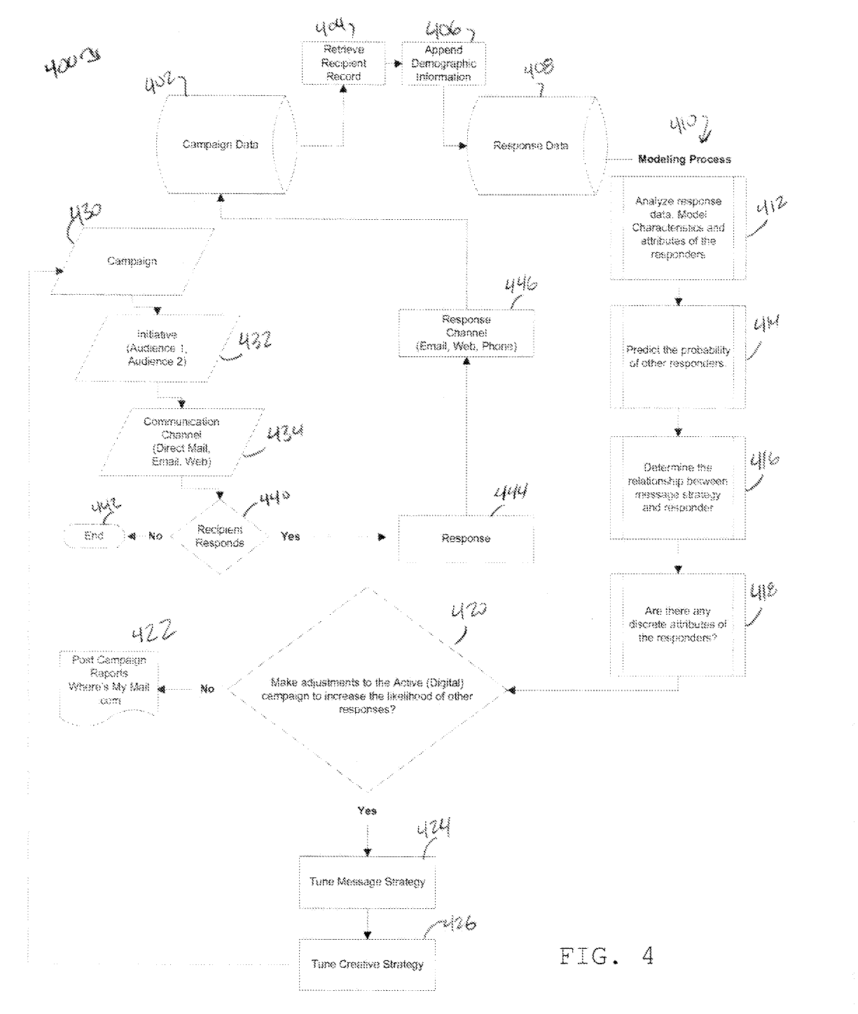

A method is provided for operating the system described above, without limitation. A flowchart diagram 400 is provided as FIG. 4 to illustrate a method of operating the system, according to an embodiment of the present invention. Skilled artisans will appreciate that the flowchart 400 of FIG. 4 is provided to illustrate one embodiment of the present invention, and is not intended to be limiting in any way. Operation of the system may begin with establishing campaign data. (Block 402). The campaign data may be stored in a database. The operation may also include receiving a recipient record. (Block 404). Demographic information may be appended with the campaign data, such as the recipient record. (Block 406). The system may also include response data. The response data may be stored in a database, which may be the same or a different database as the database that stores the campaign data. (Block 408).

The campaign data and/or response data may be analyzed using a computerized system. The data may be analyzed, for example, using a modeling process 410. The modeling process may include analyzing response data. (Block 412). The characteristics and attributes of the response data may be modeled. The system may then predict the probability of other responders. (Block 414). The relationship between a message strategy and a responder may then be analyzed. (Block 416). After the analysis of Block 416, the system may determine whether any discrete attributes of the responders exist. (Block 418).

The system may determine whether adjustments should be made to an active campaign to increase a likelihood of acquiring other responders. (Block 420). If it is determined at Block 420 that no adjustments should be made, the system may post campaign reports to the interface. (Block 422). Conversely, if it is determined at Block 420 that the campaign should be adjusted, the system may tune a message (Block 424) and/or creative strategy (Block 426). This tuning may be at least partially automated.

As an example, the system may tune the campaign by making adjustments. (Block 430). The adjustments may include creating an initiative, which might include one or more audiences. (Block 432). Additionally, the system may adjust the campaign by adjusting the communication channel. (Block 434). As discussed above, examples of communication channels may include direct mail, email, web, or other avenues of communication.

For an active campaign, the system may determine whether a response is generated by a recipient. (Block 440). If no response has been generated, the system may terminate. (Block 442). Conversely, if a response has been generated by a recipient, the system may note that the response occurred and a communication channel through which the response was received. (Block 444). The response, and information relating to the response, may be saved as campaign data, which has been discussed above. (Block 446). The system may return to the operation performed at Block 402 and again establish campaign data.

The illustrative method provided above may be operated to monitor an advertising campaign approximately continuously. For example, when active, the method may be operated to monitor the effectiveness of a campaign. Additionally, using the system of the present invention, strategies relating to the campaign may be altered as the campaign is being operated to maximize a number of responses generated by the campaign.

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A system to enhance marketing comprising:
a monitoring engine to collect data relating to a response to a campaign;
an analysis engine for analyzing the data to generate information; and
an interface to access the information.

2. The system of claim 1, wherein the interface further comprises a dashboard to display the information and a form usable to define a campaign and manipulate the campaign that exists.

3. The system of claim 1, wherein the system is accessible via a network.

4. The system of claim 1, wherein the analysis engine manipulates the campaign in response to the data that is analyzed.

5. The system of claim 4, wherein the analysis engine manipulates the campaign substantially automatically via differentiation.

6. The system of claim 1, wherein the campaign is manipulable while the campaign is active.

7. The system of claim 6, wherein the campaign is manipulable without stopping the campaign.

8. The system of claim 1, wherein at least part of a plurality of campaigns are operable substantially simultaneously.

9. The system of claim 1, wherein the campaign is targeted for a responder.

10. The system of claim 9, further comprising a profiling engine to associate the information with the responder and a modeling engine to analyze the information associated with the responder and predict future results.

11. The system of claim 10, wherein the profiling engine associates the information with the responder and the modeling engine predicts the future results approximately instantaneously as the information is generated by the analysis engine from the data.

12. The system of claim 1, wherein the monitoring engine operates substantially continuously to collect the data.

13. A marketing enhancement system accessible via a network comprising:
a monitoring engine to collect data relating to a response to a campaign by a responder;
an analysis engine for analyzing the data to generate information; and
a profiling engine to associate the information with the responder;
a modeling engine to analyze the information associated with the responder and predict future results;
wherein a plurality of campaigns are operable substantially simultaneously.

14. The system of claim 13, further comprising an interface to access the information comprising:
a dashboard to display the information; and
a form usable to define a new campaign targeted for the responder and manipulate an existing campaign.

15. The system of claim 14, wherein the analysis engine manipulates the existing campaign in response to the data that is analyzed while the existing campaign is active and without stopping the existing campaign.

16. The system of claim 15, wherein the analysis engine manipulates the existing campaign substantially automatically via differentiation.

17. The system of claim 13, wherein the monitoring engine operates substantially continuously to collect the data; wherein the analysis engine analyzes the data and generates the information approximately instantaneously; and wherein the profiling engine associates the information with the responder approximately instantaneously.

18. A method for enhancing marketing comprising:
(a) collecting data relating to a response to a campaign from a responder using a monitoring engine;
(b) analyzing the data using an analysis engine to generate information;
(c) providing the information via an interface accessible via a network, the interface comprising a dashboard to display the information and a form usable to define a campaign and manipulate the campaign; and
(d) receiving commands via the interface to manipulate the campaign;
wherein steps (a), (b), and (c) occur approximately instantaneously;
wherein a plurality of campaigns are operable substantially simultaneously.

19. The method of claim 18, further comprising:
(e) manipulating the campaign in response to the data that is analyzed while the campaign is active and without stopping the campaign.

20. The method of claim 18, further comprising:
(f) targeting the campaign by associating the information with the responder via a profiling engine;
wherein the profiling engine associates the information with the responder approximately instantaneously as the information is generated by the analysis engine.
